(19) United States
(12) Patent Application Publication
(10) Pub. No.: US 2008/0232387 A1
(43) Pub. Date: Sep. 25, 2008

(54) Electronic Device and Method of Communication Resource Allocation

(75) Inventors: Edwin Rijpkema, Nieuwerkerk a/d Ijssel (NL); Andrei Radulescu, Eindhoven (NL); Kees Gerard Willem Goossens, Eindhoven (NL); Johan Dielissen, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/996,307

(22) PCT Filed: Jul. 14, 2006
(86) PCT No.: PCT/IB06/52411

§ 371 Date: Jan. 21, 2008

(30) Foreign Application Priority Data
Jul. 19, 2005 (EP) 05106593.6

(51) Int. Cl. H04L 29/10; H04L 12/56; H04J 3/00

(52) U.S. Cl. 370/420; 370/458; 370/461

(57) ABSTRACT

An electronic device is provided, comprising an interconnect means (N) for connecting a plurality of modules (IP; A-D, M) to enable a communication between the modules (IP; A-D, M), wherein communication resources relate to a time division multiple access based on time slots for dividing and sharing an available communication bandwidth. The electronic device furthermore comprises at least one network interface for coupling at least one of the plurality of modules (IP; A-D, M) to the interconnect means (N). The network interface (NI) is adapted to establish at least one connection to at least one further network interface (NI). The at least one connection comprises at least one channel (a d). The at least one network interface (NI) comprises at least one slot table (ST1-ST11) for reserving time slots for the at least one channel (a-d). The time slots are shared between those channels (a-d) which are associated to the same network interface (NI).

The invention relates to an electronic device, a method of communication resource allocation as well as a data processing system.

Systems on silicon show a continuous increase in complexity due to the ever increasing need for implementing new features and improvements of existing functions. This is enabled by the increasing density with which components can be integrated on an integrated circuit. At the same time the clock speed at which circuits are operated tends to increase too. The higher clock speed in combination with the increased density of components has reduced the area which can operate synchronously within the same clock domain. This has created the need for a modular approach. According to such an approach the processing system comprises a plurality of relatively independent, complex modules. In conventional processing systems the systems modules usually communicate to each other via a bus. As the number of modules increases however, this way of communication is no longer practical for the following reasons. On the one hand the large number of modules forms a too high bus load, and the bus constitutes a communication bottleneck as it enables only one device to send data to the bus.

A communication network forms an effective way to overcome these disadvantages. Networks on chip (NoC) have received considerable attention recently as a solution to the interconnect problem in highly-complex chips. The reason is twofold. First, NoCs help resolve the electrical problems in new deep-submicron technologies, as they structure and manage global wires. At the same time they share wires, lowering their number and increasing their utilization. NoCs can also be energy efficient and reliable and are scalable compared to buses. Second, NoCs also decouple computation from communication, which is essential in managing the design of billion-transistor chips. NoCs achieve this decoupling because they are traditionally designed using protocol stacks, which provide well-defined interfaces separating communication service usage from service implementation.

NoCs differ from off-chip networks mainly in their constraints and synchronization. Typically, resource constraints are tighter on chip than off chip. Storage (i.e., memory) and computation resources are relatively more expensive, whereas the number of point-to-point links is larger on chip than off chip. Storage is expensive, because general-purpose on-chip memory, such as RAMs, occupy a large area. Having the memory distributed in the network components in relatively small sizes is even worse, as the overhead area in the memory then becomes dominant.

A network on chip (NoC) typically consists of a plurality of routers and network interfaces. The routers are connected in a specific typology (e.g. mesh, torus, fat-tree). Routers serve as network nodes and are used to transport data from a source network interface to a destination network interface by routing data on a correct path to the destination on a static basis (i.e., route is predetermined and does not change), or on a dynamic basis (i.e., route can change depending e.g., on the NoC load to avoid hot spots). Routers can also implement time guarantees (e.g., rate-based, deadline-based, or using pipelined circuits in a TDMA fashion). The communication over the network on chip is based on connections which are in turn build on top of channels. A channel is an unidirectional path through the network from a source to a destination. More details on a router architecture can be found in, A router architecture for networks on silicon, by Edwin Rijpkema, Kees Goossens, and Paul Wielage, In PROGRESS, October 2001, which is incorporated by reference.

Typically, network interfaces are connected to an IP block (intellectual property), which may represent any kind of data processing unit or also be a memory, bridge, etc. In particular, the network interfaces constitute a communication interface between the IP blocks and the network. The network interface is usually compatible with the existing bus interfaces. Accordingly, the network interfaces are designed to handle data sequentialisation (fitting the offered command, flags, address, and data on a fixed-width (e.g., 32 bits) signal group) and packetization (adding the packet headers and trailers needed internally by the network). The network interfaces may also implement packet scheduling, which can include timing guarantees and admission control.

A cost-effective way of providing time-related guarantees (i.e., throughput, latency and jitter) is to use pipelined circuits in a TDMA (Time Division Multiple Access) fashion, which is advantageous as it requires less buffer space compared to rate-based and deadline-based schemes on systems on chip (SoC) which have tight synchronization.

At each slot, a data item is moved from one network component to the next one, i.e. between routers or between a router and a network interface. Therefore, when a slot is reserved at an output port, the next slot must be reserved on the following output port along the path between a source and a destination module, and so on.

When multiple connections with timing guarantees are set up, the slot allocation must be performed such that there are no clashes (i.e., there is no slot allocated to more than one connection). The task of finding an optimum slot allocation for a given network topology i.e. a given number of routers and network interfaces, and a set of connections between IP blocks is a highly computational-intensive problem.

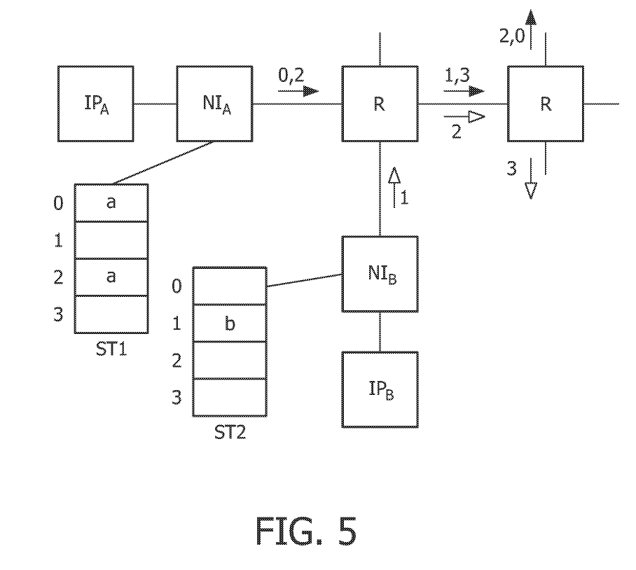

FIG. 5 shows a basic representation of part of a network on chip according to the prior art. Here, a first and second IP block IPA, IPB each with an associated network interface NIA, NIB are shown. Furthermore, two routers R are shown. The two IP blocks IPA, IPB communicate over the network. The two network interfaces NIA, NIB each comprise a slot table ST1, ST2, respectively, containing four time slots 0-3. The first IP block IPA requires a channel which has two slots reserved in the first slot table ST1 associated to the first network interface NIA. The second IP block IPB requires a channel b which has only one slot reserved in the second slot table ST2 associated to the second network interface NIB. The path of the first channel a is indicated by the solid headed arrows while the path of the second channel b is indicated by the open headed arrows. The slots in the two slot tables ST1, ST2 have been reserved such that the flits do not contend inside the network. The numbers arranged next to the solid headed and open headed arrows represent the slots for the respective channel in the particular link. The first channel a has the slots 0 and 2 reserved in the first slot table ST1 while the second channel b has the slot 1 reserved in the second slot table ST2.

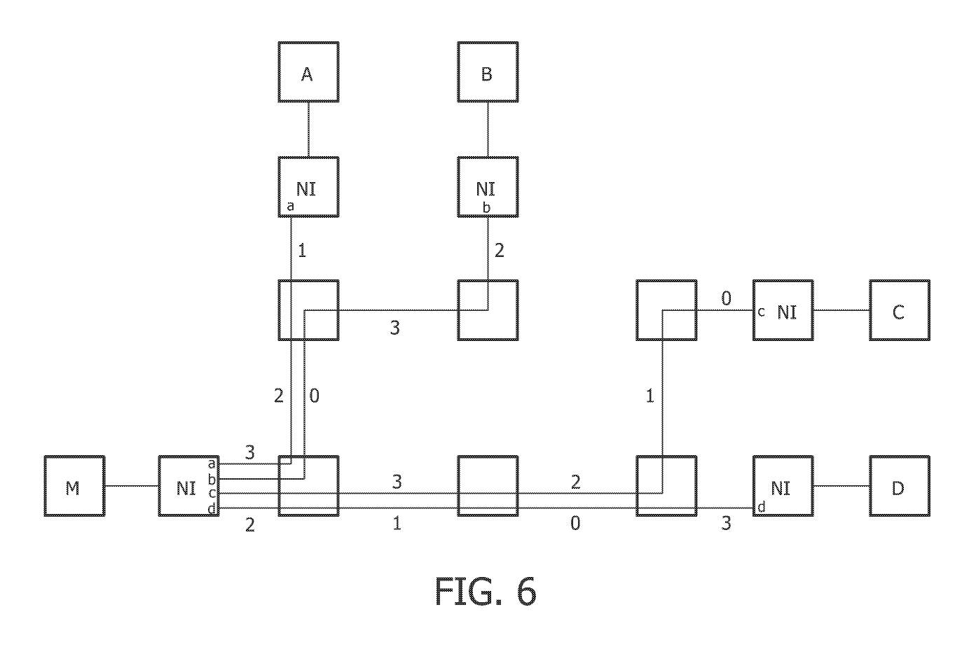

FIG. 6 shows a basic representation of network on chip connecting several IP blocks according to the prior art.

As an example, the network uses slot tables of size 8, and the IP block M performs reads to the other IP blocks that each require 1/32 of the link bandwidth. Each of the four connections from M to A, B, C and D must reserve a slot (⅛ of the link bandwidth). Together, the four connections reserve 4 slots, i.e., ½ of the link bandwidth, whereas, together, they only use ⅛ of the link bandwidth. This is clearly a non-optimal usage of the available bandwidth as well as the network resources.

It is an object of the invention to provide an electronic device and a method of communication resource allocation with a more efficient allocation of communication resources.

This object is solved by an electronic device according to claim 1, a method of communication resource allocation according to claim 12 and a data processing system according to claim 13.

An electronic device is provided, comprising an interconnect means for connecting a plurality of modules to enable a communication between the modules, wherein communication resources relate to a time division multiple access based on time slots for dividing and sharing an available communication bandwidth. The electronic device furthermore comprises at least one network interface for coupling at least one of the plurality of modules to the interconnect means. The network interface is adapted to establish at least one connection to at least one further network interface. The at least one connection comprises at least one channel. The at least one network interface comprises at least one slot table for reserving time slots for the at least one channel. The time slots are shared between those channels which are associated to the same network interface.

Therefore, the available bandwidth can be used more efficiently if several channels relate to the same network interface as the channels share at least one time slot.

According to an aspect of the invention, at least one arbiter unit is provided for arbitrating the time slots reserved for the at least one channel such that the time slots are shared between those channels which are associated to the same network interface. Accordingly, the arbiter can ensure that the available time slots are shared between the channels on a fair basis such that all channels get sufficient bandwidth.

According to a further aspect of the invention, an arbiter unit is arranged in a network interface to which several channels are associated to such that the arbitration can be performed and controlled by the shared network interface.

According to a further aspect of the invention, a first network interface receives data from at least a second and third network interface over at least a first and second channel, wherein the at least first and second channel share at least one time slot. Accordingly, the first network interface is the destination of the first and second channel.

According to still a further aspect of the invention, a first network interface sends data to at least a second and third network interface over at least a first and second channel, wherein the at least first and second channel share at least one time slot such that the first network interface is the source of the first and second channel.

The invention also relates to a method for communication resource allocation within an electronic device having an interconnect means and at least one network interface. A plurality of modules is connected by the interconnect means to enable a communication between the modules. The communication resource relates to a time division multiple access based on time slots for dividing and sharing an available communication bandwidth. At least one of the plurality of modules can be coupled to the interconnect means by means of a network interface. At least one connection is established to at least one further network interface. The at least one connection comprises at least one channel. Time slots are reserved for the at least one channel in the at least one time slot. The time slots are shared between those channels which are associated to the same network interface.

The invention relates to the idea that some of the communication resources are shared for a set of channels instead of allocating communication resources to each of the channels within the set of channels. This can be performed if several different channels are associated to a single network interface. This may occur if the network interface serves as a source network interface, i.e. issuing request commands and receiving responses (e.g., read transactions), or as a destination network interface, i.e. receiving request commands (e.g., write transactions). As some of the communication resources need to be shared among a set of channels, an arbitration can be provided to ensure the communication resources are allocated to each of the channels were required. However, an arbitration is not required if the application running on the system on chip ensures that multiple channels are used in a mutually exclusive way. This is in particular advantageous if the different channels within the set of channels are shared. In particular, time slots reserved in a slot table may be used as a shared communication resource such that several channels share at least one time slot.

The invention is now described in more detail with reference to the drawings.

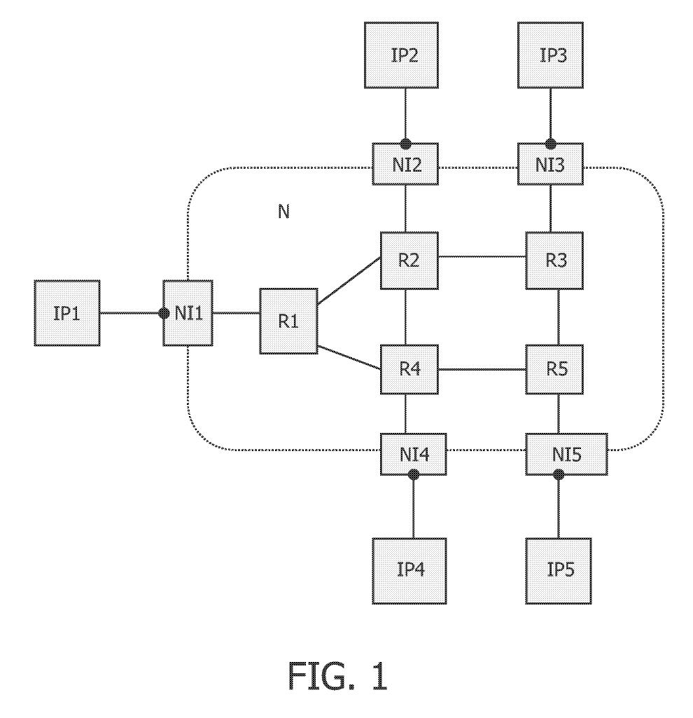

FIG. 1 shows a block diagram of a network on chip architecture according to the present invention;

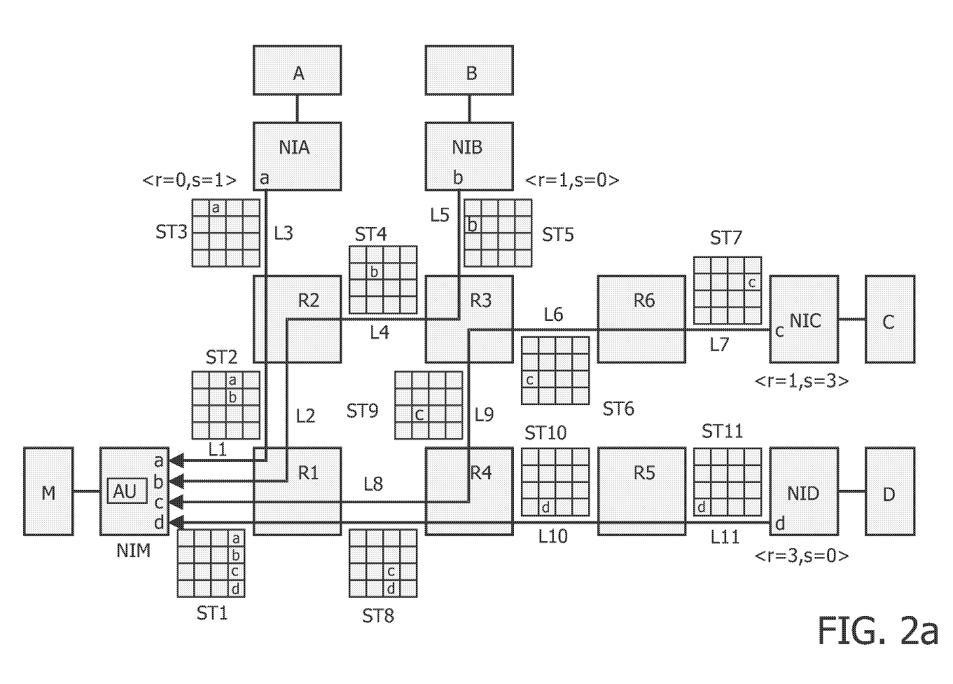

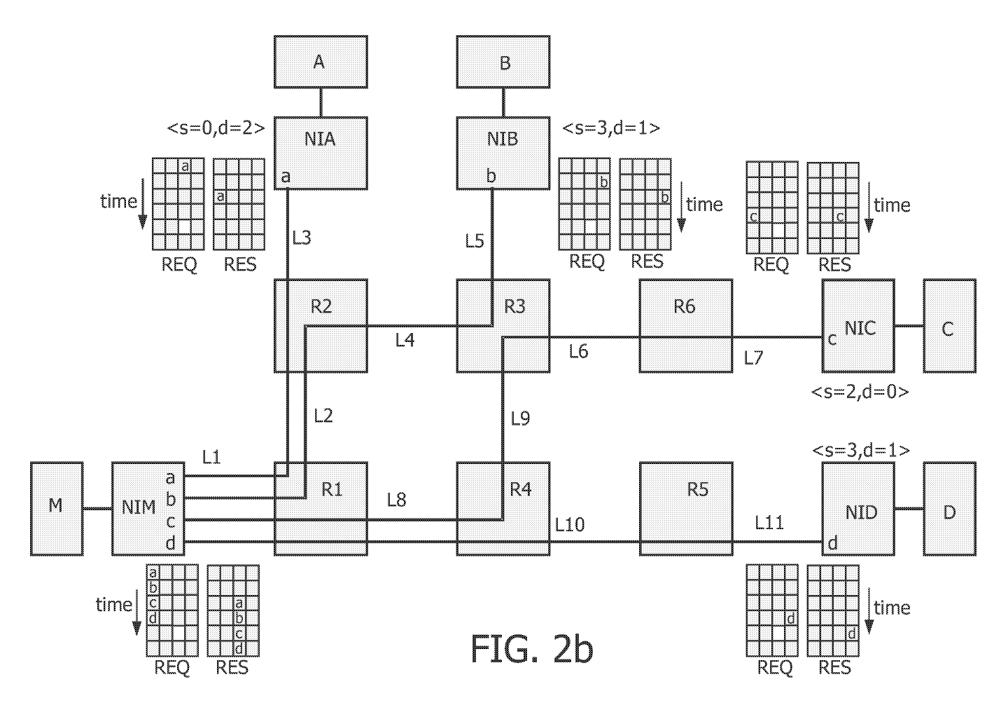

FIG. 2a shows a basic representation of a network on chip connecting several IP blocks according to a first embodiment;

FIG. 2b shows a basic representation of a network on chip connecting several IP blocks according to a second embodiment;

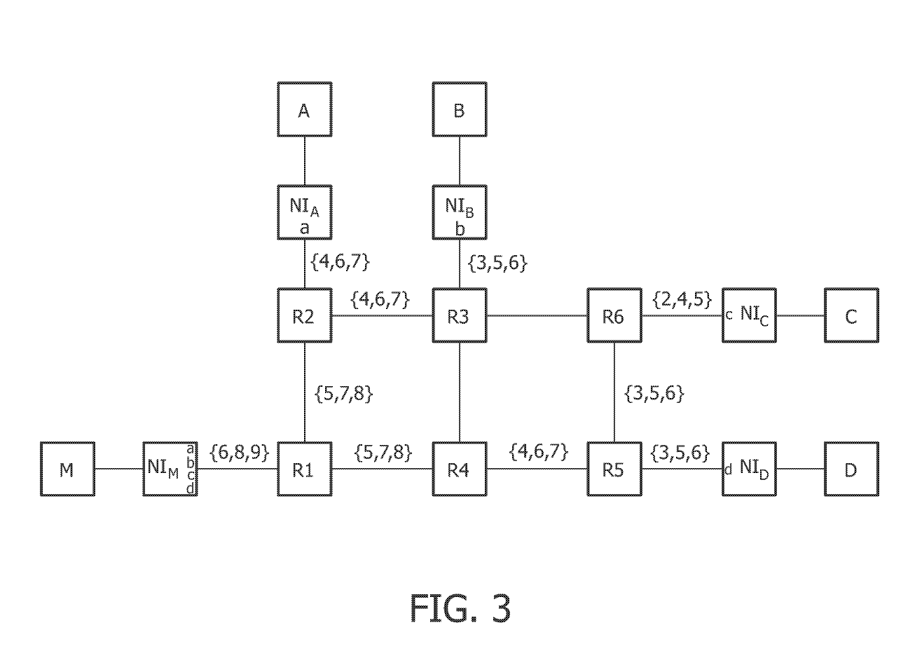

FIG. 3 shows a representation of a block diagram of a network on chip according to a third embodiment;

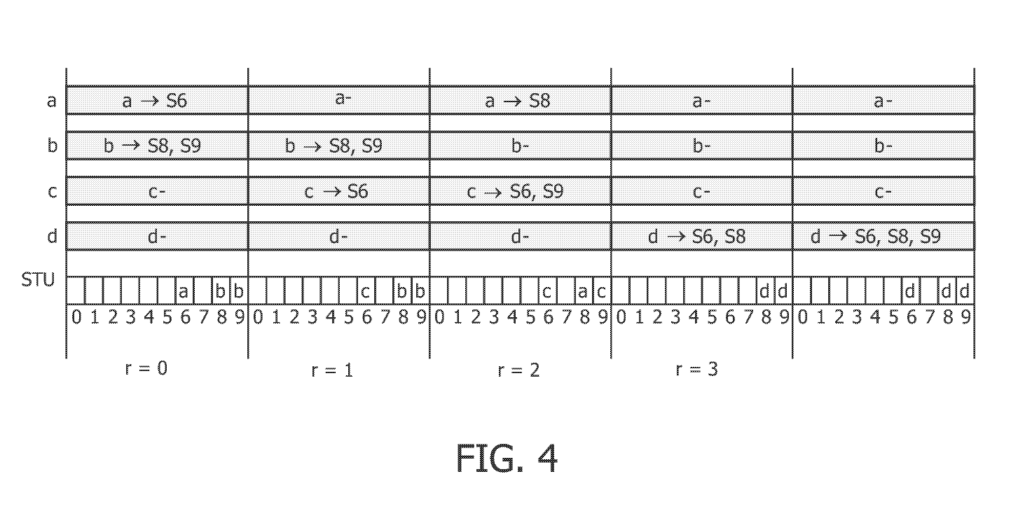

FIG. 4 shows a representation of a time diagram showing the avoidance of collisions for a set of channels;

FIG. 5 shows a basic representation of part of a network on chip according to the prior art; and

FIG. 6 shows a basic representation of network on chip connecting several IP blocks according to the prior art.

The following embodiments relate to systems on chip, i.e. a plurality of modules on the same die, multiple dies (e.g. system in a package), or on multiple (separate) chips which communicate with each other via some kind of interconnect. The interconnect may be embodied as a network on chip NOC. The network on chip may include wires, bus, time-division multiplexing, switch, and/or routers within a network. At the transport layer of said network, the communication between the modules is performed over connections. A connection is considered as a set of channels, each having a set of connection properties, between a first module and at least one second module. For a connection between a first module and a single second module, the connection may comprise two channels, namely one from the first module to the second module, i.e. the request channel, and a second channel from the second to the first module, i.e. the response channel. Therefore, a connection or the path of the connection through the network, i.e. the connection path comprises at least one channel. In other words, a channel corresponds to the connection path of the connection if only one channel is used. If two channels are used as mentioned above, one channel may provide the connection path e.g. from the master (source) to the slave (destination), while the second channel may provide the connection path from the slave to the master. Accordingly, for a typical connection, the connection path may comprise two channels. The connection properties may include ordering (data transport in order), flow control (a remote buffer is reserved for a connection, and a data producer will be allowed to send data only when it is guaranteed that space is available for the produced data), throughput (a lower bound on throughput is guaranteed), latency (upper bound for latency is guaranteed), the lossiness (dropping of data), transmission termination, transaction completion, data correctness, priority, or data delivery.

FIG. 1 shows a block diagram of the basic architecture of a network on chip according to the present invention. The system comprises several so-called intellectual property blocks IPs IP1-IP5 (computation elements, memories or a subsystem which may internally contain interconnect modules and which may be arranged on several chips) which are each connected to a network N via a network interface NI, respectively. The network N comprises a plurality of routers R1-R5, which are connected to adjacent routers via respective network links.

The network interfaces NI1-NI5 are used as interfaces between the IP blocks IP1-IP5 and the network N. The network interfaces NI1-NI5 are provided to manage the communication of the respective IP blocks IP1-IP5 and the network N, so that the IP blocks IP1-IP5 can perform their dedicated operation without having to deal with the communication with the network N or other IP blocks. The IP blocks IP1-IP5 may act as masters, i.e. initiating a request, or may act as slaves, i.e. receiving a request from a master and processing the request accordingly.

For a contention-free routing the data to be transferred over the network is injected such that no data contention occurs. The injection of data as performed by the network interfaces NI is based on flits, i.e. a fix size sub-packet which relates to the smallest synchronization entity.

FIG. 2a shows a basic representation of a network on chip connecting several IP blocks according to a first embodiment. Here, five IP blocks A, B, C, D and M are shown. A network interface NI is associated to each of the IP blocks A-D, M. Furthermore, six routers R R1-R6 are shown. To improve the clarity of the drawing, the links between the six routers R and between the routers R and network interfaces NI are not depicted. Four channels a, b, c and d are required for communicating with the IP blocks A, B, C and D and the IP block M, respectively. All channels a, b, c and d are present between the IP block M and the other IP blocks. A single slot is reserved for each of the channels. Preferably, a slot table ST1-ST11 is associated to each of the unidirectional links in the network. Despite the fact that slot tables are logically associated with each link, in some implementations the slot tables do not exist physically on every link (for example, one implementation may have slot tables only in the network interfaces) Each slot table ST1-ST11 has four slots S and a slot table rotation r. All four channels a, b, c and d stretch from the network interface associated to the IP block M to the network interfaces NI of the other IP blocks A-D. Therefore, each of the four channels will require a slot in the respective slot tables.

Each of the network interfaces NIA-NIM comprises a slot table ST1, ST3, ST5, ST7, and ST11. Furthermore, the network interfaces comprise a slot counter s and a counter r for counting a slot table rotation. As the allocation of the time slots in the slot table is performed by sharing time slots among a set of channels instead of reserving time slots for each of the channels, a significant amount of bandwidth can be saved. The actual reservation of the bandwidth for a set of channels which share a time slot is performed by allocating a time slot and the slot table rotation. For example, in FIG. 2a, the network interface NIA reserves a slot S=1 with a slot table rotation of r=0; <r=0, S=1>. Accordingly, the slot S=1 is reserved within the first slot table rotation. The time slot for the network interface NIB is reserved at the first time slot S=0 but for the second slot table rotation r=1. The time slot for the network interface NIC is reserved in the time slot S=3 for the second slot table rotation r=1.

Therefore, the slot table according to this embodiment comprises four slots (S=0, . . . , S=3). The leftmost slot is the slot S=0 and the rightmost slot is the slot S=3. When the last slot S=3 has been reached, the next slot will be the first slot S=0 within the second slot table rotation, i.e. r=1. In this embodiment, four slot table rotations, i.e. r=0, . . . , r=3 are depicted.

The network interface NID uses a time slot S=0 within the fourth slot table rotation r=3. Accordingly, the result within the slot table ST1 associated to the network interface NIM is such that the data is always received in the same slot, namely S=3, but within four slot table rotations. As all four channels a-d use the slot S=3, no contention will occur and the bandwidth reservation is sufficient, as the channels a-d will occupy the time slot within subsequent slot table rotations. The value of the slot table rotation is computed such that no clashes are present when data is transferred in the shared time slots. In the first embodiment, which relates to a case where the network interface NIM is the destination of all four channels a-d, the data from the IP blocks A-D arrive in a fixed order. It should be noted that the order does not necessarily have to be a, b, c, d but any other order is also possible. Moreover, there could be more than 1 slots assigned for a set of connections a, b,c, d.

In this embodiment, the bandwidth reservation is an absolute bandwidth reservation as a fixed order is present. In the network interface NIM which is the destination of the four channels a-d, an arbiter unit AU is present for arbitrating the available bandwidth reservation between the respective channels. Such an arbiter unit AU may also be present in one or all of the other network interfaces NIA-NID.

The particular reservation of time slots for the different channels can be performed during the configuration of a connection. The values of the communication resources associated to the connections may be changed during run time. The allocation of time slots is preferably performed within a slot allocating unit SA which may in turn be implemented by a respective IP block.

For example, if the IP block M performs blocking reads, then no further measures (e.g., arbiters) need to be taken to avoid contention and collisions. Another example where no further measures need to be taken when slots are shared is when the application itself ensures multiple channels are used in a mutually exclusive way.

However, if the possibility of contention or collisions is present (e.g., when pipelined reads are allowed, multiple responses may arrive at the same time), then the network interface NI associated to the IP block M must ensure that at most one outstanding read is present if the IP block M issues non-blocking reads.

In addition or alternatively, the network interface associated to the IP block M may provide additional control information to the network interfaces associated to the IP blocks A, B, C and D, respectively. This additional control information can be used by the respective network interfaces associated to the IP blocks A-D to decide when to introduce data into the network on chip.

In FIG. 2a, one time slot within the slot table is allocated to the whole set of channels. Accordingly, the time slot 3 is associated to the link between the network interface NI associated to the IP block M and the first router R1, as well as between the sixth router R6 and the NI associates to the IP block C. The time slot 2 is associated to the link between the first router R1 and the second and fourth router R2, R4, respectively. The time slot 1 is associated between the fourth and fifth router R4, R5 as well as to the link between the second router R2 and the network interface associated to the IP block A as well as the link between the second and third router R2, R3. The time slot 0 is associated to the link between the router R5 and the network interface NI associated to the IP block D, associated to the link between the fifth and fourth router R5 and R4 as well as to the link between the third router R3 and the network interface associated to the IP block B.

If, however, multiple slots are allocated to the respective links in the network on chip, collisions can be avoided at two levels of granularity. The collisions can be avoided within a revolution of a slot table. This can be used to assign different channels to different time slots (slots are not shared). Furthermore, the collision can be avoided over the revolutions of the slot table. Accordingly, different channels can communicate in different slot table revolutions (slots are shared).

In addition or alternatively, collisions between data sent on a set of channels for which slots have been collectively allocated, can be achieved by avoiding collisions within a revolution of a slot table and/or over revolutions of the slot table.

FIG. 2b shows a basic representation of a network on chip connecting several IP blocks according to a second embodiment. The structure of the network on chip according to FIG. 2b corresponds to the structure as depicted in FIG. 2a. The connections between the routers and the network interfaces are not shown to increase the clarity of the figure. In this embodiment, a narrow cast connection is present with the network interface NIM as the source. Accordingly, the network interface NIM schedules a request in the reserved slots. The required arbitration can be performed between outgoing channels a-d for example by a (weighted) round robin, rate based, priority based, nested slot tables arbitration scheme. To avoid any clashes on the responsive channels from the IP blocks A-D, the responses of those IP blocks are scheduled such that they arrive at the network interface NIM after a fixed delay. In this embodiment, the fixed delay is 10 time slots. This can for example be performed by programming a delay in the network interfaces associated to the IP blocks A-D, i.e. the slave network interface. The delay is used to specify after how many slot table rotations the network interface is scheduled to send to the requested response.

This is in particular advantageous as an increased flexibility is present when the requests and responses are sent. On the other hand, this scheme will only work for convergent response channels, several channels having one single destination.

The delay as required according to the second embodiment can be programmed in a register within the network interface or the delay may also be encoded within the request of the network interface NIM.

The delay as introduced according to the second embodiment is a relative bandwidth reservation as the delay is relative to the received request.

FIG. 3 shows a representation of a block diagram of a network on chip according to a third embodiment. The structure of the network on chip according to FIG. 3 substantially corresponds to the structure of the network on chip as shown in FIG. 2. Here, all of the four channels a-d are associated to the network interface NIM associated to the IP block M. A set of three time slots is allocated to the four channels a-d (it should be noted that different numbers for the channels, numbers for the time slots as well as for the paths can be used as well).

As the channels transmit data from NIⱼ, j ε {A, B, C, D} to NI_{M}, NIⱼ, j ε {A, B, C, D} are called the source NIs and NI_{M} the destination NI.

Therefore, it should be noted that the slot allocation may be different for the respective source network interfaces. One way of representing the time slots of a set of channels is to use the set of allocated slots for these channels at the destination network interface. Such a set of allocated slots can be referred to as the destination slot set. As an example, the destination slot set of the channels set {A, B, C, D} according to FIG. 4 is {6, 8, 9}. On the link R1-NIM, the channels a, b, c, d are allocated at the same slots (6, 8 and 9).

FIG. 4 shows a representation of a time diagram showing the avoidance of collisions for a set of channels. According to FIG. 3, a common notion of time is used by selecting the time at which the channels access the incoming link of the network interface NIM associated to the IP block M. From FIG. 4, it is apparent that no point of time is present at which more than one channel accesses the incoming link of the network interface associated to the IP block M. In other words, any collisions are avoided.

The channels a, b, c and d share the same set of slots S=7, 8 and 9 for a link. Within the first slot table rotation (r=0), the channel a uses the slot S=6, the channel b uses the slots S=8, 9 and the channels c and d do not use any slots. This can also be seen in the slot table usage STU. Thereafter, the channels a and d do not use any slots, while the channel b uses slots 8 and 9 and the channel c uses the slot s=6. Thereafter, the channel a uses slot=8, and the channel c uses the slots s=6, 9 while the channels b and d do not use any slots. During the next slot table rotation, the channels a, b and c do not use any slots, while the channel d uses the slots s=6, 8. Thereafter, the channels a,b and c do not use any slots while the channel d uses the slots s=6, 8 and 9.

When the above-mentioned additional control information is provided by the network interface NI associated to the IP block M, then it is to be determined which information is required by the network interfaces of the sources and who is to be providing such data. In particular, the data which is required corresponds to the information to obtain a timing diagram as depicted in FIG. 4. Each of the source network interfaces NI must be provided with those slots to be used for each of the channels. These slots are referred to as channel slot set. For a network interface NI associated to multiple channels, multiple channel slot sets must be provided. In addition, a descriptor can be provided for indicating the timing at which the slots in the channel slot set are to be used. A descriptor can be provided for the whole channel slot set or for each of the slots individually.

Now one way of relating the descriptor to the channel slot sets is described in more detail. Here, the descriptor is associated to the tuple <n-flit, n-packet, n-transaction, or 00>. Here, the n-flit, n-packet or n-transaction indicate that n flits, packets or transactions are sent using the channel slot set of the respective descriptor. 00 indicates that the channel slot set is to be used until further notice.

The descriptor may contain further information like the number of slot table revolutions to which the channel slot set may be applied. Furthermore, the descriptor may include an integer k indicating that the channel slot set only applies to a slot table revolution r for which r corresponds to mod d=k, wherein the divisor d corresponds to a system-wide constant or is programmed on a per channel set basis.

Now an example of the first embodiment is described, wherein the destination network interface NI issues read requests towards a set of other network interfaces NI. The channels from the other network interfaces NI, i.e. the source network interfaces towards the first network interface are considered as a convergent channel set such that the first network interface corresponds to the destination network interface NI. This may be obtained by a narrowcast service.

A second example of the first embodiment relates to the case where several network interfaces require to write data to the same network interface. Here, the allocation scheme described according to the first embodiment is advantageous as the time slots are collectively allocated to the set of channels and not to the individual channels. Accordingly, communication resources are saved and the latency of a communication is reduced.

The above-mentioned descriptor is preferably provided by the destination network interface NI. The destination network interface NI may embed the respective information in the packets or messages which are sent to the source network interface NI. Alternatively, also dedicated packets may be introduced. In the above-mentioned first embodiment, the information may be encoded with the messages of the read request. For the second example, a write request is sent to the destination network interface NI and the destination network interface encodes the information in the received request acknowledgement.

Additionally or alternatively, a further unit may provide the required additional information. This can for example be performed by a resource which is similar to a CPU being responsible for the management of the connections. Such a resource may allocate slots to the set of channels when for different uses or different applications different source network interfaces are present communicating to the same destination network interface. Here, lower cost may be provided alternative to allocating the resources for all of the cases.

The above-mentioned allocation scheme can be embodied in a system on chip which is based on networks on chip as interconnect. In particular, this is possible for a slot-table based approach to provide guaranteed services. Advantageously, the silicon cost is reduced and the latency is also reduced for a case where a set of channels is present. This may in particular be advantageous for any system which uses a shared memory communication for example for writing two memories or for systems having network interfaces that read data from several places.

Although in the above embodiments a network on chip has been described as interconnect, the principles of the invention can also be applied to other interconnects like a bus or switches. Also the principles of the invention may be applied to networks stretching over several chips. Furthermore, although in the above embodiments a communication has been described based on time-division multiple access (TDMA) also other communications are possible like a rate based communication or other possibilities to divide the available bandwidth between the respective communications or connections.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be construed as limiting the scope of the claims.

1. Electronic device, comprising:
an interconnect means (N) for connecting a plurality of modules (IP) to enable a communication between the modules (IP), wherein the communication resource relate to a time-division multiple access based on time slots for dividing and sharing an available communication bandwidth; and
at least one network interface (NI) for coupling at least one of the plurality of modules (IP) to the interconnect means (N), wherein the network interface (NI) is adapted to establish at least one connection to at least one further network interface (NI), wherein the at least one connection each comprises at least one channel (a-d), wherein the at least one network interface (NI) comprises at least one slot table (ST1-ST11) for reserving time slots for the at least one channel;
wherein time slots are shared between those channels (a-d) which are associated to the same network interface (NI).

2. Electronic device according to claim 1, further comprising at least one arbiter unit (AU) for arbitrating the time slots reserved for the at least one channel such that the time slots are shared between those channels (a-d), which are associated to the same network interface (NI).

3. Electronic device according to claim 1, wherein the network interface (NIM), to which several channels (a-d) are associated to, comprises one of the at least one arbiter unit (AU).

4. Electronic device according to claim 3, wherein
the interconnect means (N) comprises a plurality of network interfaces (NIA-NID, NIM) and
a plurality of routers (R1-R6) for routing data between the network interfaces.

5. Electronic device according to claim 3, wherein a first network interface (NIM) receives data from at least a second and third network interface (NIA-NID) over at least a first and second channel (a-d), wherein the at least first and second channel (a-d) share at least one time slot.

6. Electronic device according to claim 3, wherein a first network interface (NIM) sends data to at least a second and third network interface (NIA-NID) over at least a first and second channel (a-d), wherein the at least first and second channel share at least one time slot.

7. Electronic device according to claim 6, wherein the first network interface (NIM) receives the data from the at least second and third network interface (NIA-NID) after a delay.

8. Electronic device according to claim 7, wherein the at least second and third network interface (NIA-NID) respond to data from the first network interface (NIM) after a second and third delay, respectively.

9. Electronic device according to claim 7, wherein the delay to respond to the request from the first network interface (NI) is programmed in a register within the at least one second and third network interface (NI1-NID).

10. Electronic device according to claim 7, wherein the first network interface (NIM) is adapted to forward information regarding the delay of the response to the at least one second and third network interface (NIA-NID).

11. Electronic device according to claim 10, wherein the first network interface (NIM) is adapted to forward information regarding the delay of the response of the at least one second and third network interface (NIA-NID) with each request.

12. Method of communication resource allocation within an electronic device having an interconnect means for coupling a plurality of modules, and at least one network interface (NI) for coupling at least one of the plurality of modules, comprising the steps of:
connecting a plurality of modules (IP; A-D, M) to enable a communication between the modules, wherein the communication resources relate to a time division multiple access based on time slots for dividing and sharing an available communication bandwidth,
coupling at least one of the plurality of modules to the interconnect means (N),
establishing at least one connection to at least one network interface, wherein the at least one connection comprises at least one channel (a-d),
reserving time slots in a slot table of a network interface for at least one channel (a-d) and
sharing time slots between those channels (a-d) which are associated to the same network interface (NI).

13. Data processing system, comprising:
an interconnect means (N) for connecting a plurality of modules (IP) to enable a communication between the modules (IP), wherein the communication resource relate to a time-division multiple access based on time slots for dividing and sharing an available communication bandwidth; and
at least one network interface (NI) for coupling at least one of the plurality of modules (IP) to the interconnect means (N), wherein the network interface (NI) is adapted to establish at least one connection to at least one further network interface (NI), wherein the at least one connection each comprises at least one channel (a-d), wherein the at least one network interface (NI) comprises at least one slot table (ST1-ST11) for reserving time slots for the at least one channel;
wherein time slots are shared between those channels (a-d) which are associated to the same network interface (NI).
